(19) United States
(12) Patent Application Publication
(10) Pub. No.: US 2012/0320993 A1
(43) Pub. Date: Dec. 20, 2012

(54) APPARATUS AND METHOD FOR MITIGATING THE EFFECTS OF PACKET LOSS ON DIGITAL VIDEO STREAMS

(75) Inventor: Torbjörn Gannholm, Bromma (SE)

(73) Assignee: GOOGLE INC., Mountain View, CA (US)

(21) Appl. No.: 13/159,589

(22) Filed: Jun. 14, 2011

(51) Int. Cl. H04N 7/26

(52) U.S. Cl. 375/240.27; 375/240.25; 375/E07.027; 375/E07.189

(57) ABSTRACT

Apparatuses, systems, and methods for mitigating the effects of patent loss on a video stream are disclosed. The method can include encoding and transmitting a video stream by separating the video stream into a plurality of component video streams, such that each component video stream includes pixel color values associated with a color component of the color space, encoding at least a portion of the component video streams into component bitstreams, packetizing at least a portion of the component bitstreams into a plurality of packets such that no one packet of the plurality of packets includes color values corresponding to each of the plurality of color components for any frame of the plurality of frames, using a processor, and transmitting the plurality of packets.

### TECHNICAL FIELD

The present disclosure relates in general to video encoding and decoding.

### BACKGROUND

An increasing number of applications today make use of digital media for various purposes including, for example, remote business meetings via video conferencing, high definition video entertainment, video advertisements, and sharing of user-generated videos. As technology is evolving, users have higher expectations for media quality and, for example, expect high resolution video even when transmitted over communications channels having limited bandwidth.

To permit transmission of digital video streams while limiting bandwidth consumption, a number of video compression schemes have been devised, including formats such as VPx, promulgated by Google, Inc. of Mountain View, Calif., and H.264, a standard promulgated by ITU-T Video Coding Experts Group (VCEG) and the ISO/IEC Moving Picture Experts Group (MPEG), including present and future versions thereof. H.264 is also known as MPEG-4 Part 10 or MPEG-4 AVC (formally, ISO/IEC 14496-10).

### SUMMARY

Disclosed herein are exemplary approaches to mitigating the effects of packet loss on a digital video stream.

In one exemplary approach, a method for encoding and transmitting a video stream, the video stream having a plurality of frames with pixels having at least one color value, each color value corresponding to a color component of a color space is disclosed. The method includes separating the video stream into a plurality of component video streams, such that each component video stream includes pixel color values associated with a color component of the color space, encoding at least a portion of the component video streams into component bitstreams, packetizing at least a portion of the component bistreams into a plurality of packets such that no one packet of the plurality of packets includes color values corresponding to each of the plurality of color components for any frame of the plurality of frames, using a processor, and transmitting the plurality of packets.

In another exemplary approach, a method for video stream transmission of component bitstreams, each encoded from a component video stream of a video stream, the video stream and each of the component video streams having frames is disclosed. The method includes determining a required bandwidth to transmit all of the component bitstreams, determining an available bandwidth for transmission of the component bitstreams to a receiving station, determining that the required bandwidth exceeds the available bandwidth, selecting at least a portion of at least one of the component bitstreams to transmit such that a frame from at least one component video stream is transmitted for each frame of the video stream, using a processor, and transmitting the selected portions of the component bitstreams to the receiving station.

In another exemplary approach, a method for receiving and decoding a video stream having a plurality of component bitstreams each having a plurality of frames is disclosed. The method includes receiving at least a portion of at least some of a plurality of component bitstreams from a transmitting station, decoding the plurality of component bitstreams, and creating a decoded video stream by combining the decoded plurality of component bitstreams.

In another exemplary approach, an apparatus for encoding a video stream, in which the video stream has a plurality of frames with pixels having color values, includes a memory and a processor configured to execute instructions stored in the computer-readable medium to separate the video stream into a plurality of component video streams, such that each component video stream includes only pixel color values associated with a particular color component of the plurality of color components. The instructions further configure the processor to maintain frame information in the plurality of component video streams such that pixel color values in each of the plurality of component video streams are associated with an originating frame of the plurality of frames, encode the component video streams into respective component bitstreams having a required bandwidth, and determine an available bandwidth for transmission of the separate component bitstreams to a receiving station. The instructions further configure the processor to select at least a portion of at least one of the separate component bitstreams to transmit such that at least some color values are transmitted for each frame of the video stream when the sum of the required bandwidth of the separate component bitstreams is greater than the available bandwidth, and transmit the selected portion of the separate component bitstreams to the receiving station.

These and other exemplary approaches will be described in additional detail hereafter.

### BRIEF DESCRIPTION OF THE DRAWINGS

The description herein makes reference to the accompanying drawings wherein like reference numerals refer to like parts throughout the several views, and wherein:

FIG. 1 is a schematic of a video encoding and decoding system;

FIG. 2 is a diagram of a video stream;

FIG. 3 is a diagram of the associations between color spaces, color components, a frame, and component frames;

FIG. 4 is a block diagram of a video compression system in accordance with one exemplary approach;

FIG. 5 is a block diagram of a video decompression system to decode a compressed bitstream;

FIG. 6 is a block diagram of an exemplary packet loss mitigation system applied to a video frame;

FIG. 7 is a flowchart of a method for encoding and transmitting a video stream; and

FIG. 8 is a flowchart of a method of receiving and decoding a video stream.

### DETAILED DESCRIPTION

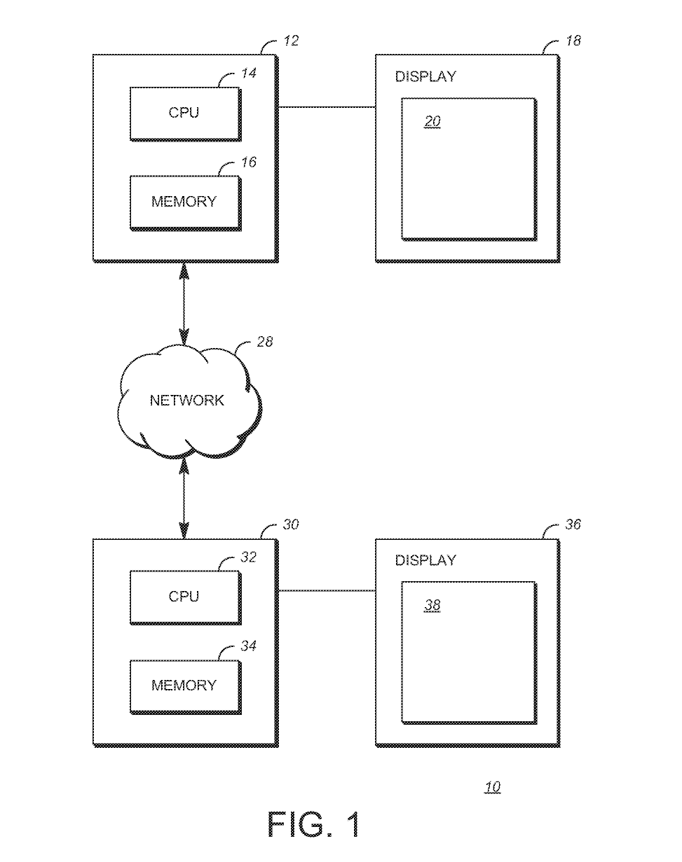

FIG. 1 is a diagram of an encoder and decoder system 10 for still or dynamic video images. An exemplary transmitting station 12 may be, for example, a computer having an internal configuration of hardware including a processor such as a central processing unit (CPU) 14 and a memory 16. CPU 14 can be a controller for controlling the operations of transmitting station 12. The CPU 14 is connected to memory 16 by, for example, a memory bus. Memory 16 may be random access memory (RAM) or any other suitable memory device. Memory 16 can store data and program instructions which are used by the CPU 14. Other suitable implementations of transmitting station 12 are possible.

A network 28 connects transmitting station 12 and a receiving station 30 for encoding and decoding of the video stream. Specifically, the video stream can be encoded by an encoder in transmitting station 12 and the encoded video stream can be decoded by a decoder in receiving station 30. Network 28 may, for example, be the Internet. Network 28 may also be a local area network (LAN), wide area network (WAN), virtual private network (VPN), or any other means of transferring the video stream from transmitting station 12.

Receiving station 30, in one example, may be a computer having an internal configuration of hardware include a processor such as a central processing unit (CPU) 32 and a memory 34. CPU 32 is a controller for controlling the operations of receiving station 30. CPU 32 can be connected to memory 34 by, for example, a memory bus. Memory 34 may be RAM or any other suitable memory device. Memory 34 stores data and program instructions which are used by CPU 32. Other suitable implementations of receiving station 30 are possible.

A display 36 configured to display a video stream can be connected to receiving station 30. Display 36 may be implemented in various ways, including by a liquid crystal display (LCD) or a cathode-ray tube (CRT). The display 36 can be configured to display a video stream decoded by the decoder in receiving station 30.

Other implementations of the encoder and decoder system 10 are possible. For example, one implementation can omit the network 28 and/or the display 36. In another implementation, a video stream may be encoded and then stored for transmission at a later time by transmitting station 12 or any other device having memory. In another implementation, additional components may be added to the encoder and decoder system 10. For example, a display or a video camera may be attached to transmitting station 12 to capture the video stream to be encoded.

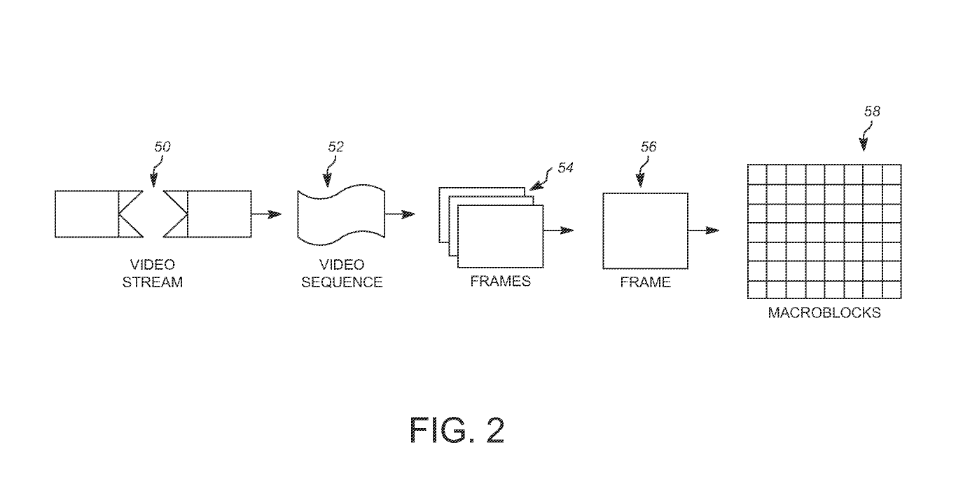

FIG. 2 is a diagram of a typical video stream 50 to be encoded and decoded. Video coding formats, such as VP8 or H.264, provide a defined hierarchy of layers for video stream 50. Video stream 50 includes a video sequence 52. At the next level, video sequence 52 consists of a number of adjacent frames 54, which can then be further subdivided into a single frame 56. At the next level, frame 56 can be divided into a series of blocks or macroblocks 58, which can contain data corresponding to, for example, a 16×16 block of displayed pixels in frame 56. Blocks 58 can also be of any other suitable size such as 16×8 pixel groups or 8×16 pixel groups. While macroblocks typically include a number of blocks (e.g., a 16×16 macroblock could include 4 8×8 blocks), unless otherwise stated, the terms macroblocks and blocks are used interchangeably herein.

The underlying frame data may include an explicit identifier for uniquely identifying a particular frame 56 from among frames 54. In another approach, frame data may include implicit identifying information, such as time data, based on the absolute or relative position of the frame 56 within the sequence of frames 54. Regardless of the particular implementation, a particular frame 56 can be readily identified from among the entire sequence of frames 54.

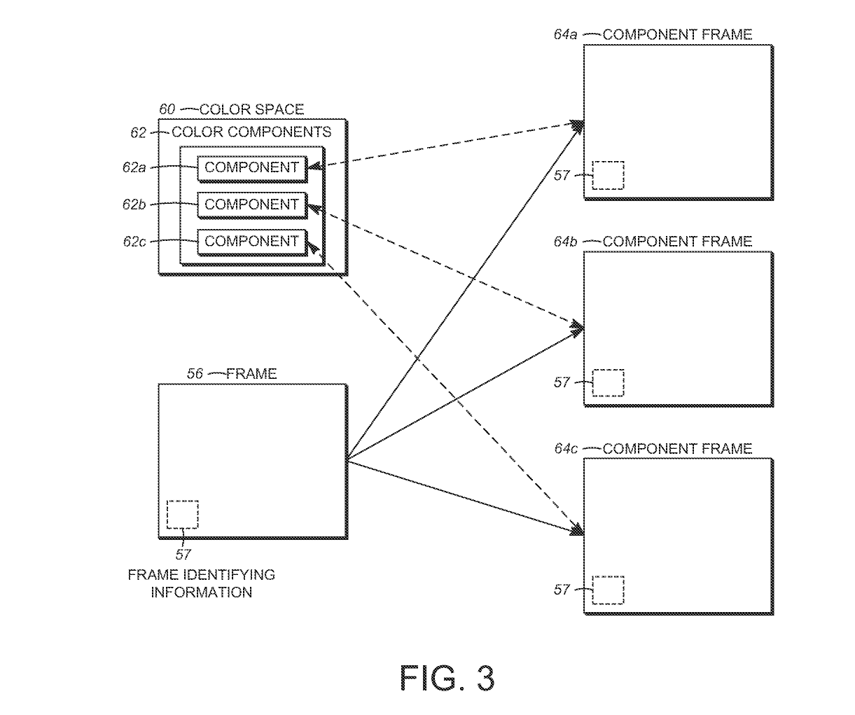

FIG. 3 is a diagram of the associations between color spaces 60, color components 62, a frame 56, and component frames 64. As explained above, each block or macroblock of the set of macroblocks 58 includes a certain number of pixels (e.g., a 16×16 macroblock includes 256 pixels) with each pixel including color data. The color data for each pixel includes a predetermined number of bits identifying its color. Various color spaces have been proposed for defining the number of bits and the format thereof used for storing pixel color data, such as color space 60. In some contexts, the term color model may be used generically as a mathematical model for representing color data as a set of numbers while the term color space may be used to indicate a specific implementation of a color model. However, the terms color model and color space may be used interchangeably herein.

A color space 60 provides a model for representing color data as a set of numeric values in a particular range and order. The color space 60 can define three or four numeric values or color components 62 to fully express the color data of a pixel. For example, a RGB color space 60 defines an R color component 62a, a G color component 62b, and a B color component 62c.

Other color spaces include: the YUV color space having Y, U, and V color components; the HSL color space having hue, saturation, and lightness color components; and the HSB color space having hue, saturation, and brightness color components. While technically distinct, the YUV color space may be referred to as a Y′CbCr color space or a YCbCr color space. These three color spaces are commonly used interchangeably to refer to any color space having a luminance color component and two chrominance color components. While this disclosure focuses on the RGB color space and associated color components, it is to be understood that the teachings disclosed herein would be equally effective with a video stream that has color data defined by an alternative color space, including those described above.

The data of macroblocks 58 generally include color data corresponding to all of the color components 62 in color space 60. For example, a block having color data corresponding to the RGB color space 60 would include bits for each pixel corresponding to each of the R, G, and B color components 62. As explained above, the color space 60 defines the format and order of the color component values of each pixel such that the color values of a pixel are represented distinctly from one another. The distinct nature of the color values allows for the implementation of data operations on the color values corresponding to a single color component of color components 62a-c.

The frame 56 may be broken down into a set of component frames 64a-c where an individual component frame (e.g., 64b) of frame 56 includes color values corresponding to a single color component (e.g., 62b) for the pixels in frame 56. As used herein, the component frames 64 refer to monochromatic frames (i.e., a frame including frame data relating to frame 56 but having pixel color values corresponding to only a single color component of the color space).

For example, each component frame 64a-c can retain any necessary frame data to maintain an association with frame 56, such as frame identifying information 57. The frame identifying information allows the component frames 64a-c to be associated with their originating frame 56, as well as to each other. For example, by retaining frame identifying information 57, a particular component frame (e.g., 64a) can be processed and displayed as a monochromatic frame should the corresponding component frames (e.g., 64b-c) be unavailable.

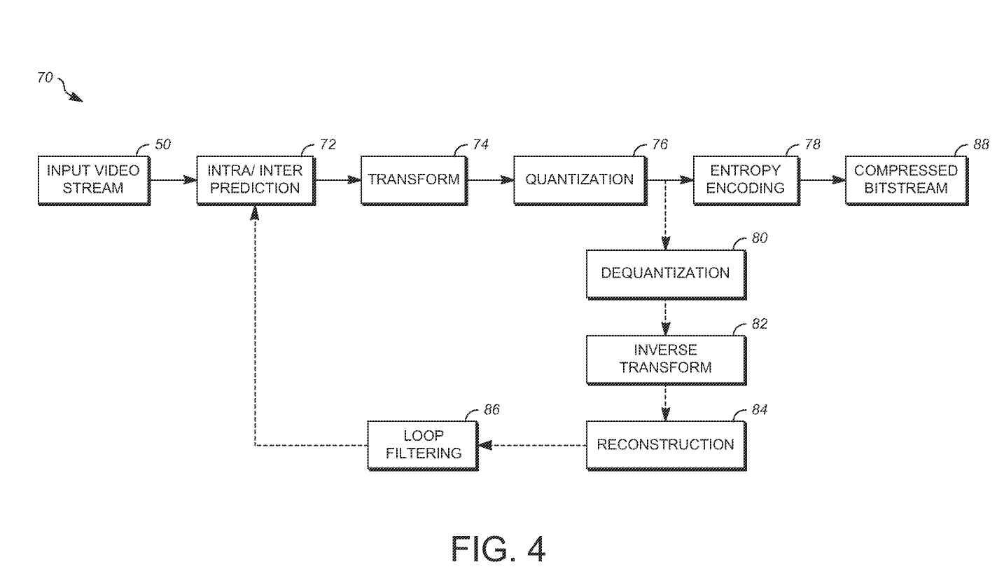

FIG. 4 is a block diagram of a video compression system in accordance with one exemplary approach. An encoder 70 encodes an input video stream 50. Encoder 70 has the following stages to perform the various functions in a forward path (shown by the solid connection lines) to produce an encoded or a compressed bitstream 88: an intra/inter prediction stage 72, a transform stage 74, a quantization stage 76 and an entropy encoding stage 78. Encoder 70 also includes a reconstruction path (shown by the dotted connection lines) to reconstruct a frame for encoding of further macroblocks. Encoder 70 has the following stages to perform the various functions in the reconstruction path: a dequantization stage 80, an inverse transform stage 82, a reconstruction stage 84 and a loop filtering stage 86. Other structural variations of encoder 70 can be used to encode input video stream 50.

When input video stream 50 is presented for encoding, each frame 56 within input video stream 50 is processed in units of macroblocks. At intra/inter prediction stage 72, each macroblock can be encoded using either intra-frame prediction (i.e., within a single frame) or inter-frame prediction (i.e. from frame to frame). In either case, a prediction macroblock can be formed. In the case of intra-prediction, a prediction macroblock can be formed from samples in the current frame that have been previously encoded and reconstructed. In the case of inter-prediction, a prediction macroblock can be formed from samples in one or more previously constructed reference frames as described in additional detail herein.

Next, still referring to FIG. 4, the prediction macroblock can be subtracted from the current macroblock at stage 72 to produce a residual macroblock (residual). Transform stage 74 transforms the residual into transform coefficients in, for example, the frequency domain, and quantization stage 76 converts the transform coefficients into discrete quantum values, which are referred to as quantized transform coefficients or quantization levels. The quantized transform coefficients are then entropy encoded by entropy encoding stage 78. The entropy-encoded coefficients, together with the information required to decode the macroblock, such as the type of prediction used, motion vectors, and quantizer value, are then output to compressed bitstream 88.

The reconstruction path in FIG. 4 is present to ensure that both encoder 70 and a decoder 100 (described below) use the same reference frames to decode compressed bitstream 88. The reconstruction path performs functions that are similar to functions that take place during the decoding process that are discussed in more detail below, including dequantizing the quantized transform coefficients at dequantization stage 80 and inverse transforming the dequantized transform coefficients at an inverse transform stage 82 in order to produce a derivative residual macroblock (derivative residual). At reconstruction stage 84, the prediction macroblock that was predicted at intra/inter prediction stage 72 can be added to the derivative residual to create a reconstructed macroblock. A loop filter 86 can then be applied to the reconstructed macroblock to reduce distortion such as blocking artifacts.

Other variations of encoder 70 can be used to encode compressed bitstream 88. For example, a non-transform based encoder can quantize the residual signal directly without transform stage 74. In another embodiment, an encoder may have quantization stage 76 and dequantization stage 80 combined into a single stage.

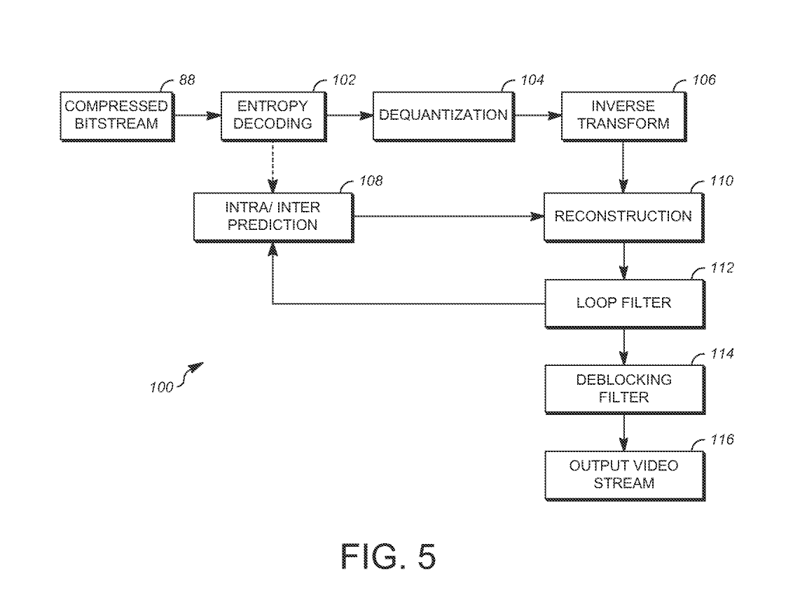

FIG. 5 is a block diagram of a video decompression system or decoder 100 to decode compressed bitstream 88. Decoder 100, similar to the reconstruction path of the encoder 70 discussed previously, includes the following stages to perform various functions to produce an output video stream 116 from compressed bitstream 88: an entropy decoding stage 102, a dequantization stage 104, an inverse transform stage 106, an intra/inter prediction stage 108, a reconstruction stage 110, a loop filter stage 112 and a deblocking filtering stage 114. Other structural variations of decoder 100 can be used to decode compressed bitstream 88.

When compressed bitstream 88 is presented for decoding, the data elements within compressed bitstream 88 can be decoded by entropy decoding stage 102 (using, for example, Context Adaptive Binary Arithmetic Decoding) to produce a set of quantized transform coefficients. Dequantization stage 104 dequantizes the quantized transform coefficients, and inverse transform stage 106 inverse transforms the dequantized transform coefficients to produce a derivative residual that can be identical to that created by the reconstruction stage in the encoder 70. Using header information decoded from the compressed bitstream 88, decoder 100 can use intra/inter prediction stage 108 to create the same prediction macroblock as was created in encoder 70. At the reconstruction stage 110, the prediction macroblock can be added to the derivative residual to create a reconstructed macroblock. The loop filter 112 can be applied to the reconstructed macroblock to reduce blocking artifacts. Deblocking filter 114 can be applied to the reconstructed macroblock to reduce blocking distortion, and the result is output as output video stream 116.

Other variations of decoder 100 can be used to decode compressed bitstream 88. For example, a decoder may produce output video stream 116 without deblocking filtering stage 114.

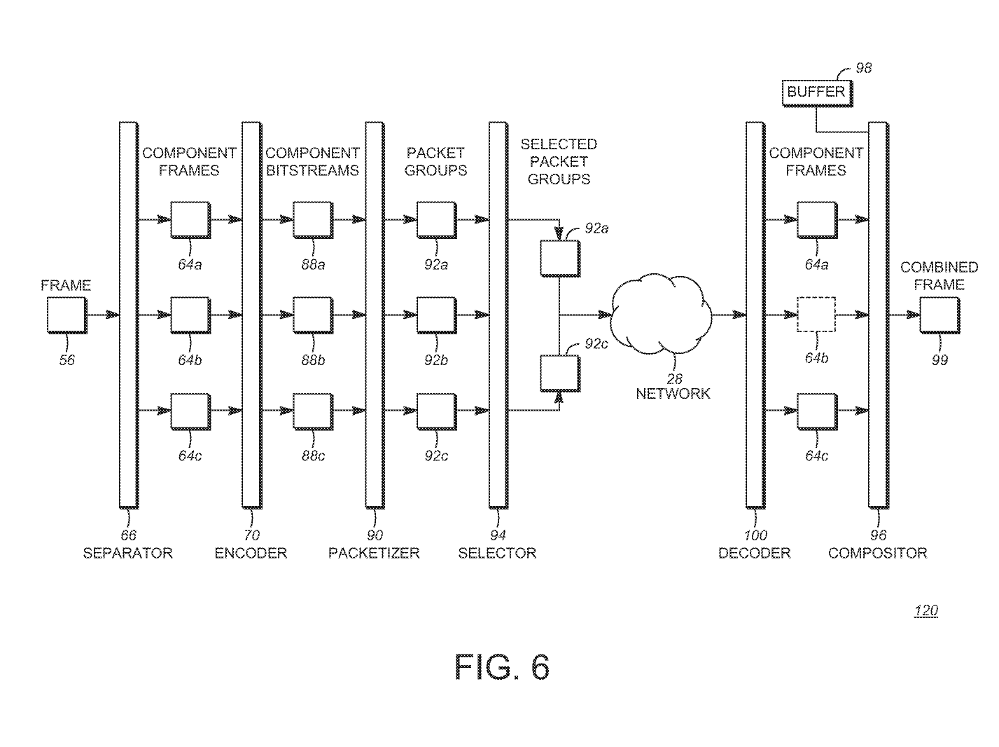

FIG. 6 is a block diagram of an exemplary packet loss mitigation system 120 applied to a video frame 56. While discussed separately from the encoder 70 and decoder 100, the following processing components and processing steps may be implemented together with the encoder 70 and decoder 100, or separately as pre-encoding, post-encoding, or post-decoding components. In overview, the encoder 70 and decoder 100 are supplemented with (or extended to provide) a separator 66, a packetizer 90, a selector 94, and a compositor 96.

The separator 66 separates the video stream 50 on a frame-by-frame basis into multiple component video streams, with each component video stream being a stream of component frames 64a-c. As explained above, each component frame 64a-c retains frame identifying information 57, but only includes pixel color values corresponding to a single color component of color components 62a-c of the defining color space 60. For example, the separator 66 separates frame 56 into component frames 64a-c each including only pixel color values corresponding to one of the color components 62a-c. After separation, the component video streams are separately encoded into encoded component bitstreams 88a-c by the encoder 70.

Following encoding, the packetizer 90 packetizes the component bitstreams 88a-c in preparation for transmission over the network 28. Packetizing the component bitstreams 88a-c involves breaking the data into packets, which are small portions or data payloads of the data, and adding network addressing information thereto. The packetizer 90 operates on each component bitstream 88a-c independently to produce packet groups 92a-c. For example, packet group 92a only includes data from component bitstream 88a. The number of packets in each packet group 92 can vary depending on the size of the component frames 64a-c. By packetizing the encoded component bitstreams 88a-c separately into packet groups 92a-c, the loss of any single packet will result only in the loss of all or part of one component frame 64a-c to which the lost packet corresponds.

The selector 94 optionally selects less than all of the packet groups 92a-c for transmission over the network 28. For example, when it is known that the available bandwidth is less than the sum of the required bandwidth of each component bitstream 88a-c, the selector 94 can be configured to select only certain packet groups (e.g., 92a, c). The available bandwidth may be predetermined based on a known dedicated bandwidth of the network 28. In another exemplary approach, the available bandwidth may be determined based on an explicit selection of an operator, or by an empirical analysis of the performance or packet loss of the network 28.

The selector 94 may alternatively select packet groups using other techniques. For example, the selector 94 may select packet groups based on the capability of the receiving station 30. In another example, the selector 94 may select packet groups alternately. In other words, the selector 94 may select packet groups corresponding to different color components for successive frames. After selecting at least one of the packet groups, the selected groups are transmitted to the receiving station 30 via the network 28.

Upon receipt, the decoder 100 decodes the received packet groups (e.g., 92a, c) into component video streams, each having only component frames 64a, c corresponding to color components 62a, c. As described above, the decoder 100 may only receive packet groups 92a, c as a result of an explicit selection by the selector 94. However, other scenarios are possible. For example, in an alternative scenario, the decoder 100 may only receive certain packet groups (such as 92a, c) or only a subset of the packets of one or more of the transmitted packet groups, due to packet loss on the network 28. For example, some real-time network transmission protocols may not resend lost packets. Regardless of the circumstances, the decoder 100 decodes the received data into separate component video streams. Since the packetizer 90 configured the packet groups 92 so that no one packet includes data for any one frame from all of the component bitstreams 88a-c, the loss or omission of any one packet or packet group (e.g., 92b) will at most result in the loss of a single component frame (e.g., 64b).

After decoding the received packet groups 92 into separate component video streams of component frames 64a-c, the compositor 96 combines the component frames 64a-c into a combined frame 99 having complete color data for all of the color components 62. If data for a particular color component (e.g., 62b) is unavailable due to the loss or omission of data from the corresponding component frame 64b, the compositor 96 may provide substitute data to complete the data of the combined frame 99. In one exemplary approach, the compositor 96 may maintain a buffer 98 or other memory of previously received frames. Color data for the corresponding component frame 64b from a previously received frame stored in the buffer 98 may be used by the compositor 96 when recreating the combined frame 99. In another exemplary approach, the color data of the combined frame 99 corresponding to the missing component frame 64b can be set to a default level such that the combined frame 99 is displayed, but with incorrect color data. For example, the combined frame 99 could convey the original image, but would appear to the viewer as having incorrect coloration. In another exemplary approach, the compositor 96 may elect to combine one or more of the received component frames such that the combined frame 99 is either bichromatic or monochromatic.

Other variations of packet loss mitigation system 120 are possible. For example, the selector 94 can be relocated to be before the encoder 70. In this example, the frames to be encoded would be pre-selected to avoid encoding frames that would not be transmitted.

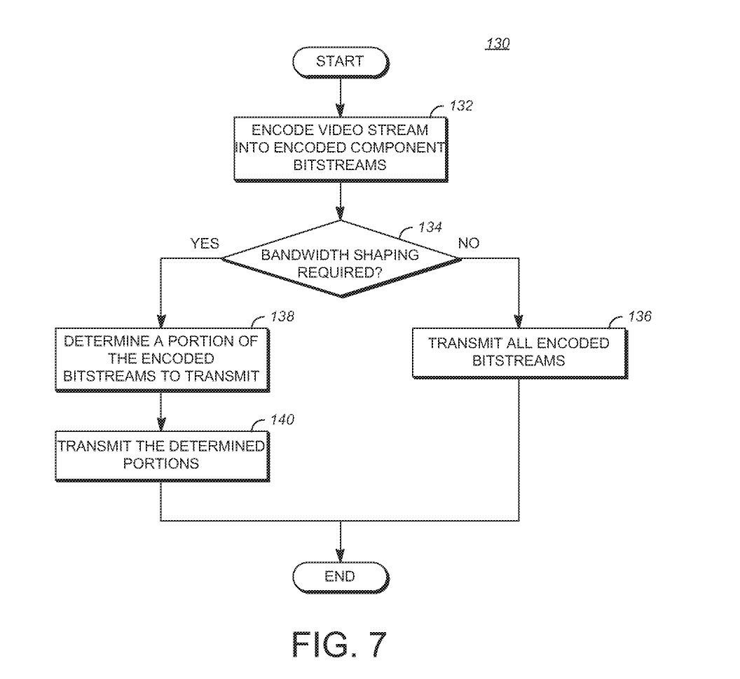

FIG. 7 is a flowchart of a method 130 for encoding and transmitting a video stream. The method 130 starts at stage 132 by encoding a video stream 50 into component bitstreams 88a-c based on component frames 64a-c corresponding to color components 62a-b. As explained above, a separator 66 separates a frame 56 into component frames 64a-c. An encoder 70 separately encodes the component frames 64a-c into component bitstreams 88a-c. A packetizer packetizes the component bitstreams 88a-c into packet groups 92a-c such that no packet contains data from more than one component frame 64a-c. Next, it is determined if bandwidth shaping is required at stage 134 based on whether the sum of the required bandwidth for each of the component bitstreams 88a-c exceeds an available bandwidth of the network 28. If bandwidth shaping is not required, all of the component bitstreams 88a-c may be transmitted at stage 136 over the network 28.

However, if it is determined that bandwidth shaping is required, a selector 94 may determine a portion of the component bitstreams 88a-c to transmit at stage 138. As explained above, the selector 94 selects packet groups 92a-c corresponding to component bitstreams 88a-c. The selector 94 may select the entirety of one or more of the component bitstreams 88a-c, such that one of the component bitstreams is not selected so long as the selected bitstreams have a combined required bandwidth less than the available bandwidth. Moreover, selection of a particular component bitstream (e.g., 88a) may be to the exclusion of the remaining component bitstreams (e.g., 88b, c). In another exemplary approach, the selector 94 may select at least a portion of at least one or more of the component bitstreams, such that the selected portions have a combined required bandwidth less than the available bandwidth. For example, the selector 94 may alternate between the component bitstreams such that data from the component bitstreams are interleaved with each other. In another exemplary approach, the selection may be based on the particularities of the underlying color space such that the selected component bitstream corresponds to the component frame most suitable for monochromatic or reduced color display. The selected portions of the component bitstreams are then transmitted at stage 140 over the network 28 to the receiving station 30.

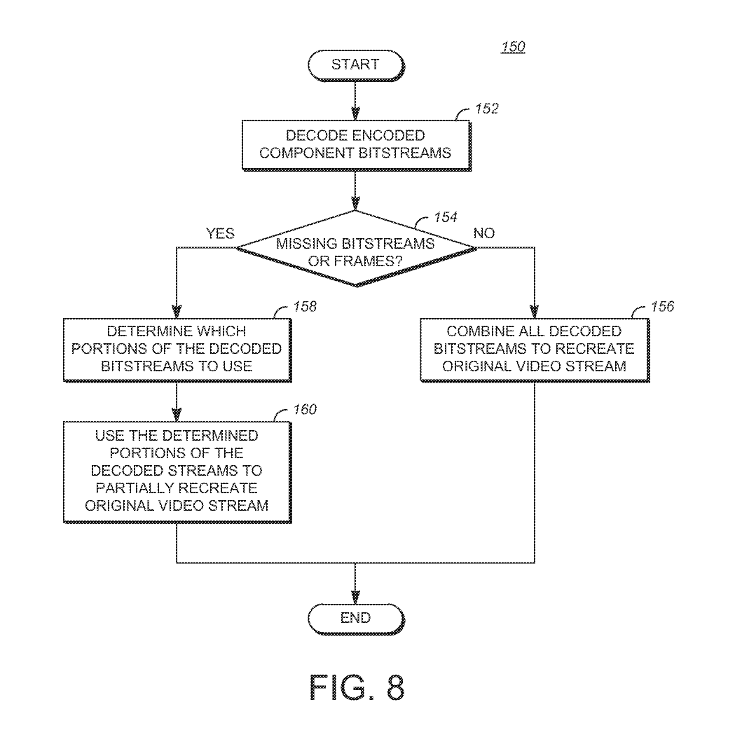

FIG. 8 is a flowchart of a method 150 of receiving and decoding a video stream. The method 150 begins by decoding component bitstreams separated based on component frames at stage 152. As explained above, each component bitstream includes component frames having color values corresponding to a particular color component. However, each component frame includes other necessary frame identifying information such that upon decoding, the component frames may be recombined into their original frame having complete color data. Due to bandwidth constraints or packet loss during transmission, less than all of data of the component bitstreams may have been received. Accordingly, it must be determined if there are any missing streams or component frames at stage 154. If there are no missing component flumes, a compositor 96 may use the frame identifying information 57 of each component frame to create a combined frame 99 and video stream at stage 156.

However, if there are missing component frames, it must be determined which portions of the decoded component frames to use at stage 158. For example, if an entire component bitstream has been omitted due to bandwidth constraints, it may be determined that the recreated video stream should be displayed to the viewer as a monochromatic video stream using the color data from only one of the component frames. In another exemplary approach, it may be determined that only a portion of a particular component bitstream was omitted or lost such that previously received component frames corresponding to the missing data is available for substitution. Based on the determination of which portions of the decoded streams to use, the determined portions may be used to recreate the original video stream. For example, the video stream may be recreated as a monochromatic video stream using color data from less than all of the component frames. In another exemplary approach, color data from a previously received component frame stored in a buffer 98 or other memory may substituted for the missing color data.

The above-described embodiments of encoding or decoding may illustrate some exemplary encoding techniques. However, in general, encoding and decoding as those terms are used in the claims are understood to mean compression, decompression, transformation or any other change to data whatsoever.

The embodiments of transmitting station 12 and/or receiving station 30 (and the algorithms, methods, instructions etc. stored thereon and/or executed thereby) can be realized in hardware, software, or any combination thereof including, for example, IP cores, ASICS, programmable logic arrays, optical processors, programmable logic controllers, microcode, firmware, microcontrollers, servers, microprocessors, digital signal processors or any other suitable circuit. In the claims, the term “processor” should be understood as encompassing any the foregoing, either singly or in combination. The terms “signal” and “data” are used interchangeably. Further, portions of transmitting station 12 and receiving station 30 do not necessarily have to be implemented in the same manner.

Further, in one embodiment, for example, transmitting station 12 or receiving station 30 can be implemented using a general purpose computer/processor with a computer program that, when executed, carries out any of the respective methods, algorithms and/or instructions described herein. In addition or alternatively, for example, a special purpose computer/processor can be utilized which can contain specialized hardware for carrying out any of the methods, algorithms, or instructions described herein.

Transmitting station 12 and receiving station 30 can, for example, be implemented on computers in a screencasting or a videoconferencing system. Alternatively, transmitting station 12 can be implemented on a server and receiving station 30 can be implemented on a device separate from the server, such as a hand-held communications device (i.e. a cell phone). In this instance, transmitting station 12 can encode content using an encoder into an encoded video signal and transmit the encoded video signal to the communications device. In turn, the communications device can then decode the encoded video signal using a decoder. Alternatively, the communications device can decode content stored locally on the communications device (i.e. no transmission is necessary). Other suitable transmitting station 12 and receiving station 30 implementation schemes are available. For example, receiving station 30 can be a personal computer rather than a portable communications device.

Further, all or a portion of embodiments of the present invention can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A method for encoding and transmitting a video stream, the video stream having a plurality of frames with pixels having at least one color value, each color value corresponding to a color component of a color space, the method comprising:
separating the video stream into a plurality of component video streams, such that each component video stream includes pixel color values associated with a color component of the color space;
encoding at least a portion of the component video streams into component bitstreams;
packetizing at least a portion of the component bistreams into a plurality of packets such that no one packet of the plurality of packets includes color values corresponding to each of the plurality of color components for any frame of the plurality of frames, using a processor; and
transmitting the plurality of packets.

2. The method of claim 1 wherein the color space is one of:
a RGB color space with red, green, and blue color components,
a YUV color space with Y, U, and V color components,
a HSB color space with hue, saturation, and brightness color components, or
a HSL color space with hue, saturation, and lightness color components.

3. The method of claim 1, wherein the component bitstreams each have a required bandwidth and the method further comprises:
determining an available bandwidth for transmission of the component bitstreams to a receiving station; and
if the sum of the required bandwidth of the component bitstreams is greater than the available bandwidth, selecting at least a portion of at least one of the component bitstreams to transmit such that at least some color values are transmitted for each frame of the video stream.

4. The method of claim 3, wherein packetizing at least a portion of the component bitstreams comprises packetizing the selected portion of the component bitstreams.

5. The method of claim 3, wherein selecting at least a portion of at least one of the component bitstreams to transmit comprises:
determining an anticipated bandwidth for at least one of the component video streams; and
selecting the portion of the component video streams to be encoded based on the anticipated bandwidths and the available bandwidth.

6. The method of claim 3, wherein selecting at least a portion of at least one of the component bitstreams to transmit comprises:
selecting the entirety of one or more of the component bitstreams, such that one of the component bitstreams is not selected and that the selected component bitstreams have a required bandwidth less than the available bandwidth.

7. The method of claim 3, wherein selecting at least a portion of at least one of the component bitstreams to transmit comprises:
selecting at least a portion of at least one or more of the component bitstreams, such that the selected portions have a required bandwidth less than the available bandwidth.

8. The method of claim 7, wherein selecting at least a portion of at least one of the component bitstreams to transmit further comprises:
selecting the portions such that the portions of the component bitstreams are interleaved with each other.

9. The method of claim 1, wherein separating the video stream into a plurality of component video streams further comprises:
separating each frame of the plurality of frames of the video stream into a plurality of component frames such that each component frame includes only pixel color values associated with a particular color component of the color space.

10. The method of claim 9, wherein maintaining frame information in the plurality of component video streams comprises:
maintaining an association between each frame and the plurality component frames separated therefrom such that a particular component frame is associated with its originating frame as well as to other component frames of the plurality of component frames separated from the same originating frame.

11. A method for video stream transmission of component bitstreams, each encoded from a component video stream of a video stream, the video stream and each of the component video streams having frames, the method comprising:
determining a required bandwidth to transmit all of the component bitstreams;
determining an available bandwidth for transmission of the component bitstreams to a receiving station;
determining that the required bandwidth exceeds the available bandwidth;
selecting at least a portion of at least one of the component bitstreams to transmit such that a frame from at least one component video stream is transmitted for each frame of the video stream, using a processor; and
transmitting the selected portions of the component bitstreams to the receiving station.

12. The method of claim 11 wherein each of the component video streams comprises one of:
a red, green, or blue component video stream,
a Y, U, or V component video stream,
a hue, saturation, or brightness component video stream, or
a hue, saturation, or lightness component video stream.

13. The method of claim 11, wherein transmitting the selected portions of the component bitstreams comprises:
packetizing the selected portions of the component bitstreams within respective groups of one or more packets such that any given packet contains at least a portion of only one of the component bitstreams.

14. The method of claim 11, wherein there are three component bitstreams and selecting at least a portion of at least one of the component bitstreams to transmit comprises:
selecting the entirety of two of the component bitstreams, such that one of the component bitstreams is not selected and that the two selected component bitstreams have a required bandwidth that is less than the available bandwidth.

15. The method of claim 11, wherein selecting at least a portion of at least one of the component bitstreams to transmit comprises:
selecting at least a portion of at least one or more of the component bitstreams, such that the selected portions have a required bandwidth less than the available bandwidth.

16. The method of claim 15, wherein selecting at least a portion of at least one of the component bitstreams to transmit further comprises:
selecting the portions such that frames selected from each of the component bitstreams are interleaved with each other.

17. The method of claim 11, wherein transmitting the selected portions of the component bitstream to the receiving station is performed by the transmitting station or an intermediate agent.

18. A method for receiving and decoding a video stream having a plurality of component bitstreams each having a plurality of frames, the method comprising:
receiving at least a portion of at least some of a plurality of component bitstreams from a transmitting station;
decoding the plurality of component bitstreams; and
creating a decoded video stream by combining the decoded plurality of component bitstreams.

19. The method of claim 18, further comprising:
determining that there are missing component frames in one or more of the decoded component bitstreams; and
creating a substitute frame for at least one of the missing frames;

20. The method of claim 19, wherein creating a substitute frame for one of the missing frames comprises:
creating the substitute frame using a previously received frame from the component bitstream that the substitute frame was encoded within.

21. An apparatus for encoding a video stream, the video stream having a plurality of frames with pixels having color values, the apparatus comprising:
a memory; and
a processor configured to execute instructions stored in the memory to:
separate the video stream into a plurality of component video streams, such that each component video stream includes only pixel color values associated with a particular color component of the plurality of color components;
maintain frame information in the plurality of component video streams such that pixel color values in each of the plurality of component video streams are associated with an originating frame of the plurality of frames;
encode the component video streams into respective component bitstreams having a required bandwidth;
determine an available bandwidth for transmission of the component bitstreams to a receiving station;
if the sum of the required bandwidth of the component bitstreams is greater than the available bandwidth:
select at least a portion of at least one of the component bitstreams to transmit such that at least some color values are transmitted for each frame of the video stream, and
transmit the selected portion of the component bitstreams to the receiving station.
